(19) United States
(12) Patent Application Publication
(10) Pub. No.: US 2008/0254164 A1
(43) Pub. Date: Oct. 16, 2008

(54) PROCESS FOR PACKAGING WINE IN ALUMINUM CANS

(76) Inventors: Gregory John Charles Stokes, Keilor (AU); Steven John Anthony Barics, Tullamarine (AU)

Correspondence Address: CONNOLLY BOVE LODGE & HUTZ LLP, 1875 EYE STREET, N.W., SUITE 1100, WASHINGTON, DC, 20036, US

(21) Appl. No.: 12/051,056

(22) Filed: Mar. 19, 2008

Related U.S. Application Data
(63) Continuation-in-part of application No. 11/863,823, filed on Sep. 28, 2007.
Application No. 11/863,823 is a continuation-in-part of application No. 10/381,726, filed on Aug. 12, 2003, now abandoned.

(30) Foreign Application Priority Data
Sep. 28, 2001 (AU) PR 8001

(51) Int. Cl. B65B 3/10; C12G 1/00

(52) U.S. Cl. 426/15; 426/131

(57) ABSTRACT

A filled two-piece aluminium can contains a wine that has less than 35 ppm of free SO₂, less than 300 ppm of chlorides, less than 800 ppm of sulfates, and less than 250 ppm of total sulfur dioxide. The can is sealed with an aluminium closure such that the pressure within the can is at a minimum value necessary to prevent buckling of the can, typically 20 psi. The inner surface of the aluminium can is coated with a corrosion resistant coating.

This application is a Continuation-In-Part of U.S. application Ser. No. 11/863,823 filed Sep. 28, 2007, which is a Continuation-In-Part of Ser. No. 10/381,726 filed Aug. 12, 2003, which is the National Stage of International Application No. PCT/AU02/00725 filed Jun. 5, 2002, and claims priority to Application No. PR 8001 filed in Australia on Sep. 28, 2001 under 35 U.S.C. § 119. The entire contents of each of the above-applications is incorporated herein by reference.

This invention relates to aluminium cans filled with wine. It also relates to a process for packaging wine in aluminium cans.

### BACKGROUND OF THE INVENTION

Wine has been produced since the times of the ancient Greeks. It has been stored in many types of containers. These have included timber, pottery and leather. The use of glass bottles has evolved as the preferred storage means for wine, particularly when stored in quantities less than one litre. While bottles are almost universally used, they have the disadvantages of having relatively high weight and being relatively fragile.

For beverages other than wine, such as beer and soft drinks, alternative packages such as metal cans and polyethylenetetraphthate (PET) bottles have been widely adopted. These offer advantages of lower weight and greater resistance to breakage. It has been proposed to store wine in such alternative containers. However, attempts to use such packaging types for wine have been generally unsuccessful. Some very low quality wines are stored in polyvinyl chloride containers. It is believed that the reasons for this lack of success in canning wine has been the relatively aggressive nature of the materials in wine and the adverse effects of the reaction products of wine and the container on the wine quality, especially taste. Wine is a complex product that typically has a pH in the range 3 to 4. This compares to beer with a pH of 5 or more and many soft drinks with pH 3 or more. However, pH itself is not the sole determinant, and it has been found that carbonated cola drinks with a pH as low as 3 may be adequately stored in PET containers. The low pH is the result of the phosphoric acid content in carbonated cola drinks. This may allow the satisfactory use of pre-coated aluminium cans and PET bottles for these beverages.

The packaging of wine in cans has been proposed but no prior attempt has been commercially successful. In Modern Metals (1981; p 28) Fred Church suggested packaging wine in two piece aluminium cans. by eliminating oxygen from the head space with nitrogen. This early proposal failed to achieve commercial success because the wines were not storage stable.

In 1992 Ferrarini et al in Ricerca Viticola Id Enologica no 8 p 59 reviewed the packaging of wine in aluminium cans. They also concluded that oxygen in the head space was to be avoided but that corrosion of the can was due to a number of contributing factors which needed to be addressed. Ferrarini noted that high internal pressures tend to accelerate the corrosion process and also indicated that pasteurization was necessary. Ferrarini et al concluded that using these guidelines white wine could be canned. One recommendation was that the wines must be pasteurised. Again these recommendations did not result in any commercially successful product. It has been realized that pasteurisation has detrimental effect on the taste and bouqet of wine and this may explain the lack of adoption of the Ferrarini recommendations.

It is an object of this invention to package wine in aluminium cans whereby the quality of the wine does not deteriorate significantly on storage.

### SUMMARY OF THE INVENTION

The invention provides in one form a filled two-piece aluminium can containing a wine characterised in that it has less than 35 ppm of free SO₂, less than 300 ppm of chlorides, less than 800 ppm of sulfates, and preferably less than 250 ppm of total sulfur dioxide; the can being sealed with an aluminium closure such that the pressure within the can is a minimum pressure sufficient to prevent buckling and damage to the lining, typically in the order of 20 psi. and wherein the inner surface of the aluminium can is coated with a corrosion resistant coating.

This invention is in part predicated on the discovery that the failure in prior art attempts to find a reliable and repeatable process was to concentrate on controlling the canning process rather than look for wine parameters that enable wine to be stored in an aluminium can for periods in excess of six months. This invention is also predicated on the realization that corrosion of the can body and the coating is caused by microholes and cracks in the coating surface and the high content of particular anions in an acidic environment. The anions that need to be kept below critical levels are chlorides and sulfates and to a lesser extent nitrites and nitrates. As taught in the prior art free sulphur dioxide and free oxygen levels also need to be controlled.

Preferably the wine is further characterised by having total nitrates less than 30 ppm, total phosphates less than 900 ppm and acidity calculated as tartaric acid in the range g/litre to 9 g/litre. Preferably the wine contains less than 1 ppm of nitrites. Preferably the maximum oxygen content of the head space is 1% v/v.

Preferably the increase in aluminium content in wine that is stored in the can for three months in the upright position at 30° C. is a maximum of 30%.

Preferably the corrosion resistant coating is a thermoset coating.

Preferably the head space after sealing with the closure has the composition nitrogen 80-97% v/v, and carbon dioxide 2-20% v/v. Preferably liquid nitrogen is added just prior to the seaming of the closure to the body of the can.

Alternatively the wine is carbonated before the two-piece can body is filled with the wine whereby the head space after sealing is predominantly carbon dioxide. The pressure within the can has a minimum pressure sufficient to prevent buckling and damage to the lining, in the nature of cracking of the internal lining coating, the minimum pressure typically being in the order of 20 psi.

Preferably the head space for a 330 millilitre can is in the range 2-5 mm.

Preferably the wine is chilled before filling.

In contrast to the recommendations of the prior art pasteurization is not necessary to obtain acceptable shelf life for a product that is acceptable to consumers.

### DETAILED DESCRIPTION OF THE INVENTION

The wine required for the process of the present invention may be prepared by the use of particular viticulture and wine making techniques as are described below.

Alternatively the wine may be prepared by treating wine with higher than specified levels of constituents and removing or lowering the content of these constituents to those required for the present invention. In this invention the term “wine” is used quite broadly and includes still and sparkling wine as well as fortified wines and wines blended with mineral waters and fruit juices.

With regard to viticulture, the absence of undesired materials may be obtained by ensuring adverse chemical sprays are not used. The use of chemical sprays needs to be monitored as this also affects the total build up of undesired chemicals in the final wine product. Most vine diseases need heat or humidity to flourish, unpruned vines enhances this dilemma further creating the need for chemical spraying.

Shade has a major role in producing grape quality, a higher incidence of botrytis, powdery mildew and down mildew. Once again this requires chemical intervention. Sulfur based fungicides can be used but they introduce unacceptable levels of sulfur. Unpruned vines have bunches which produce soggy wine with excessive herbaceous and abhorrent flavours. Light is one of the greatest natural assets, too often forgotten and taken for granted. The focus must be “a vine in harmonious balance” within itself With the correct ratio of grapes, leaves, canes, woods and roots within this balance occurring, minimal chemical intervention is required.

Excessive irrigation's legacy is an “out of balance” crop. A crop where there is a far too abundant canopy produces shaded fruit and in turn late ripening. Also excessive irrigation prior to harvest overloads the berry with water and chemical uptake, which alters the berry's natural state. Again this often requires a chemical counter measure further down the processing line. Drip irrigation with a constant electronic soil moisture monitor is the preferred option.

Preferably grapes will be hand picked (with careful attention not to excessively damage the fruit) and should be harvested in a cool (8° C.-16° C.) environment, preferably at night. Baume in the 13.0-14.0 range with pH 3.1-3.8 for “reds” and 10.0-13.0 Baume and pH 3.0-3.5 for “whites”. Minimal sulfur dioxide dusting is required so as to minimise wild yeast degradation. It is preferred to rely upon the wild yeasts for fermentation.

For red wines, crushing and de-stemming should occur as soon as possible and preferably within 12 hours of harvesting. De-stemming before crushing is highly recommended so as to produce a higher quality wine. The advantages are an improvement in taste by not containing astringent, leafy herbaceous stems. Possible alcoholic strength increases, by as much as 0.5%, because the stems which contain water and no sugar, absorb alcohol. An increase in colour occurs by avoiding the pigments in the stems. Fermentation with stems allows for more oxygen intake at an accelerated process. We do not require speed when fermenting, only stability and quality. After de-stemming and crushing the must is pumped to a fermentation vessel, adjusted with tartaric acid, yeast levels adjusted to requirements and a minimum sulfur dioxide addition.

The vessel is fitted with a bubble system so as to allow excessive fermentation gases out, and no oxygen in. Oxygen entry occurs only when punching occurs. This amount of aeration is important for yeast multiplication and complete sugar fermentation.

Punching down the skins (every 10-12 hours) at regular intervals and maintaining an ambient temperature of approximately 25° C. is crucial in the fermentation process. Dry-cap can allow oxidisation and higher or lower temperatures create their own nemesis on the fermenting juice. Stability during maceration being the key element during the next 14-21 days. Baume is constantly monitored with a daily reduction of 0.7-1.0, Baume being the “benchmark”. When the Baume reaches 0°-1°, the pomace or grape mass is “basket pressed”.

Pressing requires careful and astute monitoring. Over-pressing creates heavy astringents, phenolics and heavy coarse tannins. Balance pressing alleviates the need for eventual heavy chemical fining, unnecessary blending and chemical intervention.

At this stage the combination of free run juice and pressed juice is transferred to pre-sulfited, sterilised used or new American Oak, French Oak stored in a naturally controlled temperature environment. The temperature range is 15° C.-25° C. After filling, the barrels are hit a few times with a rubber mallet to dislodge air bubbles and refilled to within 25 mm of the barrel opening. The barrels are fitted with an air lock and the fermentation is allowed to proceed within the barrel. This process takes 3-4 months to complete (the time factor dependent on the humidity and temperature variations in the host environment). About this stage malo-lactic fermentation occurs, either by inoculation or naturally if it is endemic in the winery.

After fermentation is complete the barrel is racked, cleaned, sterilised, lightly sulfited, filled and air locks removed. After filling, the barrels are hit a few times with a rubber mallet to dislodge air bubbles, refilled and bunged. The barrel then positioned with the bung at 30° to the vertical.

Sediment needs to be removed from young wine so that yeast cells, bacteria cells and foreign organic substances which create putrid, reduced and hydrogen sulfite can be avoided.

Aeration is another natural progression in our quest for excellence. This factor facilitates the completion of yeast transformation and the eventual stability of the wine. Within the fermentation medium, different areas of sedimentation occurs, dictating free sulfur dioxide levels to form. Racking synergises these layers into conformity. Sulfiting requirements at this stage are thus more precise.

Frequency of racking is a contentious issue, a time frame of every two to three months in the first year is quite acceptable although in reality factors such as the size of the tank or barrel, temperatures in the cellars and type of wine will dictate the cellarmaster's decision. His skill and experience will determine the final requirements. Egg white fining at the rate of 1-3 per 100 litres is required to enhance the settling of the suspended material.

After ageing in casks for 12-18 months, racking at least 3-4 times, analysing, tasting, lightly sulfiting, (if 100% necessary) acknowledging the wine is sound, free from fermentable sugars and has completely undergone malo-lactic fermentation, the wine is ready for blending. This is the final reward for the efforts put forth in the preceding 12-18 months and the months leading up to harvest.

For white wine the grapes are de-stemmed before crushing. The pH of the juice adjusted to pH 3.0-3.4 with tartaric acid. Skin contact time dependent on grape variety, sourcing region, ambient temperature and the quantity of tannins or astringent phenolic requirements. The must drained under carbon dioxide addition.

Fermentation temperature is in the range 10-16° C. A sugar content reduction of between 0.4 and 0.8 Baume is the goal. After fermentation, the wine settling and racked 10 under carbon dioxide, sulfur dioxide addition occurs.

In all procedures pertaining to white wine, exposure to air is to be avoided at all costs, and a cool temperature environment is practised. Wine prepared as described above has a free sulfur dioxide level less than 35 ppm and a total sulfur dioxide level less than 250 ppm. The level of anions that may form acids, chlorides, nitrates and sulfates are less than the prescribed maxima.

The invention may also be applied to sparkling wine where nitrogen may not be required in the head space as the carbon dioxide may be sufficient to provide the required can strength.

The two-piece cans suitable for the present invention are cans that are currently used for soft drink and beer beverages. The can linings are also similar and are typically an epoxy resin combined with a formaldehyde based cross-linking agent. Typically the film thickness used is greater than that used for beer or soft drinks. Typically 175 mg/375 ml cans have been found to lead to a suitable film thickness. The internally coated can is baked at temperatures typically in the range 165-185° C. for twenty minutes. It is important to ensure a well cross-linked impermeable film to ensure excessive levels of aluminium are not dissolved into the wine on storage.

The can filling process involves the addition of approximately 0.1 ml of liquid nitrogen just prior to seaming the closure of the body. The internal pressure in the can is typically in the order of 20 psi.

Alternatively the wine can be carbonated by mixing the wine with carbon dioxide gas in equipment known as a carbonator. This type of equipment is well known and is extensively used in the soft drink industry.

As previously discussed, the storage stability of the wine in the aluminium can is vital. In contrast to bottled wine where the head space includes oxygen, the head space in the cans of the present invention have very low levels of oxygen. This means the wine does not “age” on storage.

For test purposes, the packaged wine is stored under ambient conditions for a period of 6 months and at 30° C. for 6 months. 50% of the cans are stored upright and 50% are inverted.

The product is checked at 2 monthly intervals for Al, pH, °Brix, head space oxygen and visual inspection of the cans, 6 cans inverted and 6 cans upright per variable. Visual inspection includes lacquer conditions, staining of the lacquer and seam condition. Samples are to be retained for 12 months. Sensory evaluation uses a recognised objective system by a tasting panel.

Results for storage evaluation of a white wine are set out in Table 1. A white wine has a lower pH on average than a red wine and is more severe test on storage stability.

TABLE 1

| Storage | °Brix (20° C.) | Orientation | Al mg/L | pH |
|---|---|---|---|---|
| Initial | 6.7 | — | 0.5 | 3.40 |
| 3 months | 6.9 | Upright | 0.65 | 3.47 |
| 3 months | 6.5 | Inverted | 0.68 | 3.47 |
| 6 months | 7.0 | Upright | 0.72 | 3.49 |
| 6 months | 7.0 | Inverted | 0.68 | 3.50 |

The increase in the aluminium content in the wine after storage in a can is calculated as:

(100×aluminium content after storage−initial aluminium content) % initial aluminium content

For the wine stored for three months in the upright position at 30° C. this calculates, using the data in Table 1, as:

(100×0.65−0.5)%0.5=30%

For the wine stored for three months in the inverted position at 30° C. this calculates as:

(100×0.68−0.5%)%0.5=36%

Similar calculations from the data in Table 1 give an aluminium increase of 44% and 36% for upright and inverted storage after six months.

This data shows satisfactory storage after six months at 30° C. The acceptable quality of the wine was confirmed by the tasting panel.

In this specification, reference to values for analytes in wine, gas composition, dimensions, volumes and pressure refer to the values as determined under standard laboratory conditions of 20° C. unless the context provides otherwise.

Since modifications within the spirit and scope of the invention may be readily effected by persons skilled in the art, it is to be understood that the invention is not limited to the particular embodiment described, by way of example, hereinabove.

1. A filled two-piece aluminium can containing a wine that has less than 35 ppm of free SO₂, less than 300 ppm of chlorides and less than 800 ppm of sulfates, the can being sealed with an aluminium closure such that the there is a minimum pressure within the can sufficient to prevent buckling of the can and wherein the inner surface of the aluminium can is coated with a corrosion resistant coating.

2. A filled can as defined in claim 1 wherein the wine is characterised by having total sulphur dioxide levels less than 250 ppm.

3. A filled can as defined in claim 1 wherein the maximum oxygen content of the head space is 1% v/v.

4. A filled can as defined in claim 1 wherein the wine is carbonated.

5. A filled can as defined in claim 1 wherein the corrosion resistant coating is a thermoset coating.

6. A filled can as defined in claim 1 in which the wine is further characterised by having total nitrates less than 30 ppm, total phosphates less than 900 ppm and acidity calculated as tartaric acid in the range g/litre to 9 g/litre.

7. A filled can as defined in claim 1 in which the wine is further characterised by containing less than 1 ppm of nitrites.

8. A filled can as defined in any one of claims 1 wherein the head space in the can has the composition nitrogen 80-97% v/v and carbon dioxide 2-20% v/v.

9. A filled can as defined in claim 4 wherein the head space is predominantly carbon dioxide.

10. A process for packaging wine in two piece aluminium cans including the steps of preparing wine characterised in that it has less than 35 ppm of free SO₂, less than 300 ppm of chlorides, less than 800 ppm of sulfates; filling a two piece aluminium can body with the wine and sealing with an aluminium closure such that the pressure within the can is at a minimum value necessary to prevent buckling of the can and wherein the inner surface of the aluminium is coated with a corrosion resistant coating.

11. A process as claimed in claim 10 wherein the wine is chilled before filling.

12. A process as claimed in claim 10 wherein the wine is characterised by having total sulphur dioxide levels less than 250 ppm.

13. A process as claimed in claim 10 wherein the wine is characterised by having total nitrates less than 30 ppm, total phosphates less than 900 ppm and acidity calculated as tartaric acid in the range g/litre to 9 g/litre.

14. A process as claimed in claim 12 in which the wine is further characterised by containing less than 1 ppm of nitrites.

15. A process as claimed in claim 12 wherein the head space in the can has the composition nitrogen 80-97% v/v and carbon dioxide 2-20% v/v.

16. A process as claimed in claim 10 wherein the wine is carbonated and the head space is predominantly carbon dioxide.
